(19) United States
(12) Patent Application Publication
(10) Pub. No.: US 2016/0173965 A1
(43) Pub. Date: Jun. 16, 2016

(54) WEARABLE DEVICE

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: XI-HUAI HE, Wuhan (CN); CHUN-SHENG CHEN, New Taipei (TW)

(21) Appl. No.: 14/587,524

(22) Filed: Dec. 31, 2014

(30) Foreign Application Priority Data
Dec. 10, 2014 (CN) 201410751389.3

(51) Int. Cl. H04R 1/00; H04B 1/3827; H04M 1/725; H04W 4/00

(52) U.S. Cl. CPC H04R 1/00; H04W 4/008; H04B 1/385; H04M 1/7253; H04B 2001/3866

(57) ABSTRACT

Wearable device includes a receiving module configured to connect an electronic device, a power amplifier coupled to the receiving module, and a first speaker coupled to the power amplifier. The receiving module receives an audio file of the electronic device, and the power amplifier amplifies an audio signal of the audio file and controls the first speaker to convert an amplified audio signal to an acoustical signal for outputting.

### FIELD

The subject matter herein generally relates to a wearable device.

### BACKGROUND

Nowadays, many electronic products such as mobile phones, laptop computers, and hearing aid products need wires to connect to a user's ears.

### BRIEF DESCRIPTION OF THE DRAWINGS

Implementations of the present technology will now be described, by way of example only, with reference to the attached figures.

FIG. 1 is a block diagram of an embodiment of a wearable device and an electronic device.

FIG. 2 is a block diagram of a first detail embodiment of the wearable device and the electronic device of FIG. 1.

FIG. 3 is a block diagram of a second detail embodiment of the wearable device and the electronic device of FIG. 1.

FIG. 4 is an isometric view of the wearable device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a wearable device comprising a receiving module configured to connect an electronic device, a power amplifier coupled to the receiving module, and a first speaker coupled to the power amplifier. The receiving module is configured to receive an audio file of the electronic device, and the power amplifier is configured to amplify an audio signal of the audio file and control the first speaker to convert an amplified audio signal to an acoustical signal for outputting.

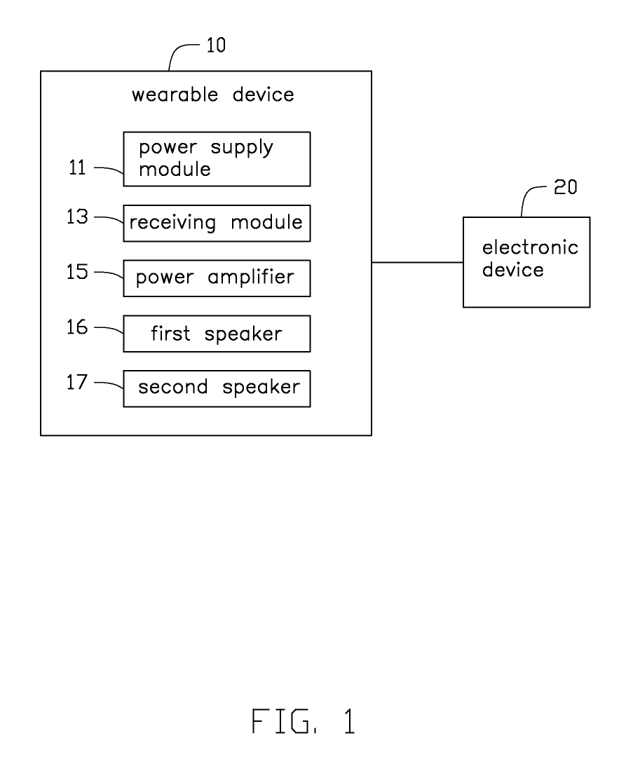

FIG. 1 illustrates an embodiment of the wearable device 10 being configured to connect an electronic device 20. The wearable device 10 can comprise a power supply module 11, a receiving module 13, a power amplifier 15, a first speaker 16 and a second speaker 17. In at least one embodiment, the electronic device 20 can be a computer or a mobile phone.

The power supply module 11 is configured to supply the power of the wearable device 10. The receiving module 13 is coupled to the electronic device 20 and is configured to receive an audio file. The power amplifier 15 is configured to amplify the audio signal of the audio file which is received by the receiving module 13, and then the power amplifier 15 controls the first speaker 16 and the second speaker 17 to convert the amplified audio signal to acoustical signal for output.

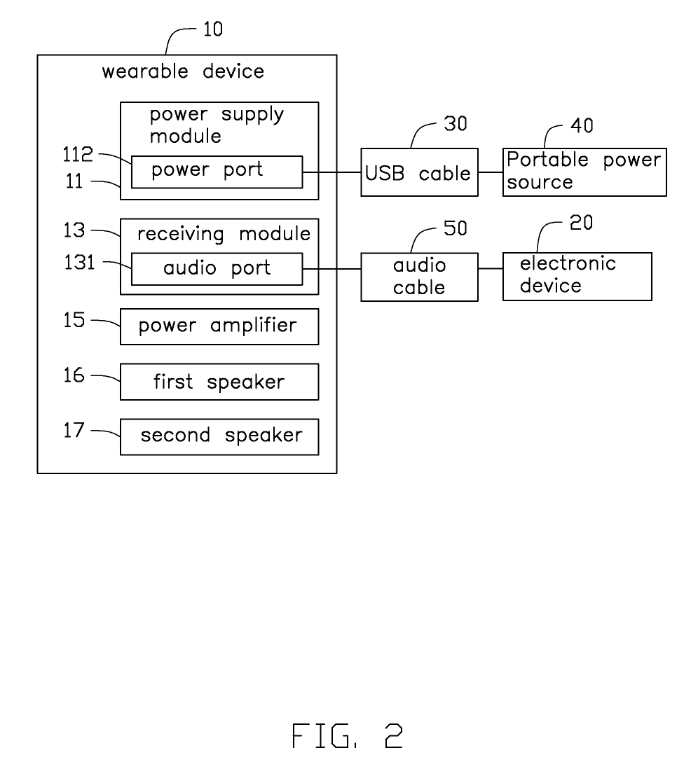

FIG. 2 illustrates a first detail embodiment of the wearable device 10 being configured to connect the electronic device 20. The power supply 11 can comprise a power port 112. The power port 112 can be connected to a portable power source 40 via a Universal Serial Bus (USB) cable 30, for allowing the portable power source 40 to supply power for the wearable device 40. The receiving module 13 can comprise an audio port 131. The audio port 131 can connect the electronic device 20 via an audio cable 50, for allowing the receiving module 13 to receive the audio file from the electronic device 20.

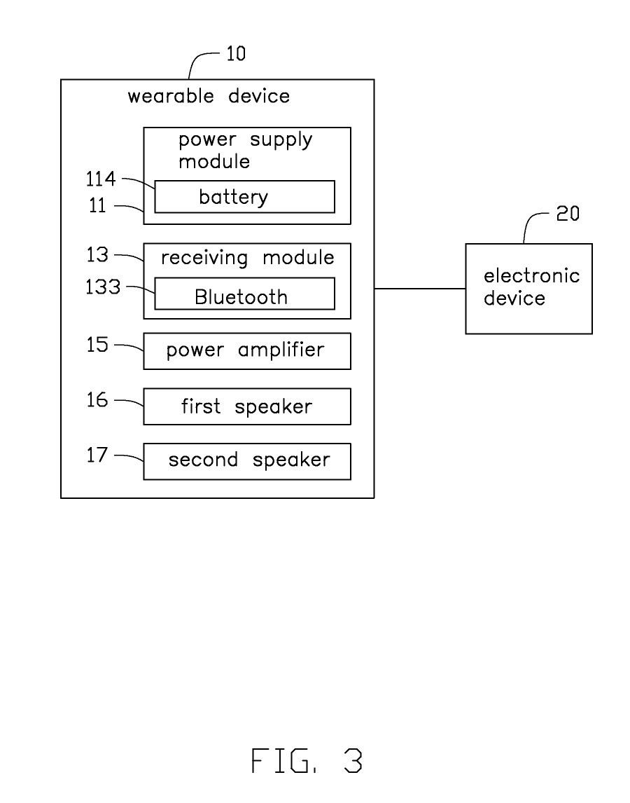

FIG. 3 illustrates a second detail embodiment of the wearable device 10 being configured to connect the electronic device 20. The power supply 11 can comprise a battery 114. The battery 14 is located in the interior of the wearable device 10 for supply the power for the wearable device 10. The receiving module 13 can comprise a BLUETOOTH 133. The receiving module 13 can connect the electronic device 20 via the BLUETOOTH 133, for allowing the receiving module 13 to receive the audio file from the electronic device 20.

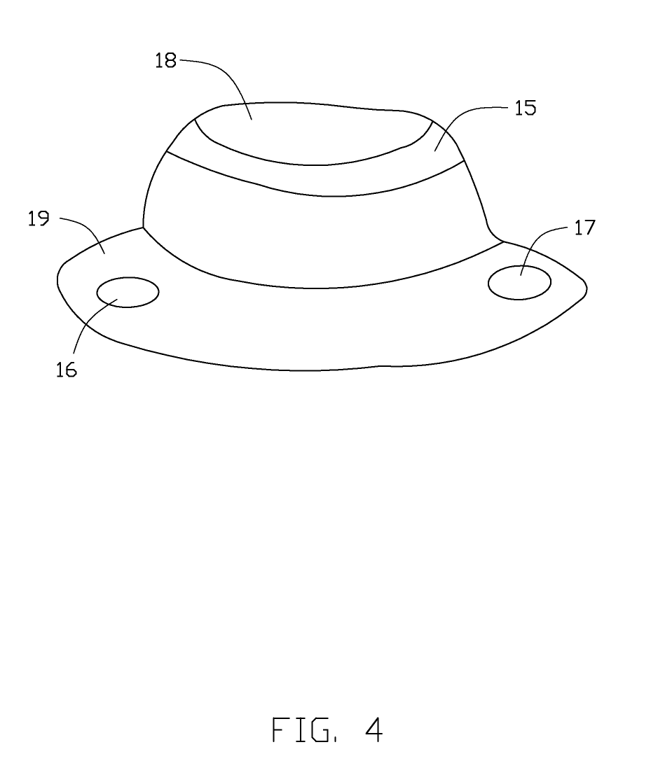

FIG. 4 illustrates an embodiment of the wearable device 10. The wearable device 10 can be a cap which can comprise a crown 18 and a cap brim 19. The power amplifier 15 can be located on the crown 18, and the first speaker 16 and the second speaker 17 can be located on opposite side of the cap brim 19.

In use, the battery 114 or the portable power source 40 supplies power for the wearable device 10. The wearable device 10 is coupled to the electronic device 20 via the audio cable 50 or the BLUETOOTH 133 for allowing the receiving module 13 to receive the audio file of the electronic device 20. The electronic device 20 plays the audio file, the power amplifier 15 amplifies the audio signal of the audio file which is received by the receiving module 13, and then the power amplifier 15 controls the first speaker 16 and the second speaker 17 to convert the amplified audio signal to acoustical signal for output. Therefore, the wearable device 10 can be put on the head of a user for easy listening to the sound of the audio file, and the wearable device 10 cannot be easily lost.

In at least one embodiment, the wearable device 10 also can be a bag, clothes, or a bracelet.

The embodiments shown and described above are only examples. Many details are often found in the art such as the other features of a wearable device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A wearable device comprising:
a receiving module configured to connect to an electronic device;
a power amplifier coupled to the receiving module; and
a first speaker coupled to the power amplifier;
wherein the receiving module is configured to receive an audio file of the electronic device, and the power amplifier is configured to amplify an audio signal of the audio file and control the first speaker to convert an amplified audio signal to an acoustical signal for outputting by the first speaker.

2. The wearable device of claim 1, further comprising a power supply module, wherein the power supply is configured to supply power for the wearable device.

3. The wearable device of claim 2, wherein the power supply module comprises a battery, and the battery is located an interior of the wearable device.

4. The wearable device of claim 2, wherein the power supply module comprises a power port, the power port is configured to connect a portable power source for allowing the portable power source to supply power for the wearable device.

5. The wearable device of claim 1, wherein the receiving module comprises an audio port, the audio port is configured to connect the electronic device via an audio cable for allowing the audio file of the electronic device to transmit to the receiving module.

6. The wearable device of claim 1, wherein the receiving module comprises a Bluetooth, the receiving module is configured to connect the electronic device via the Bluetooth for allowing the audio file of the electronic device to transmit to the receiving module.

7. The wearable device of claim 1, wherein the wearable device is a cap, and the power amplifier is located on an crown of the cap.

8. The wearable device of claim 1, wherein the wearable device further comprises a second speaker, and the first speaker and the second speaker are located on opposite sides of a brim of the cap.

9. The wearable device of claim 1, wherein the electronic device is a computer or a mobile phone.

10. A wearable device comprising:
a power supply module configured to supply power for the wearable device;
a receiving module configured to connect an electronic device for receiving an audio file of the electronic device;
a power amplifier coupled to the receiving module for amplifying an audio signal of the audio file received by the receiving module; and
a first speaker coupled to the power amplifier;
wherein after the audio signal of the audio file is amplified by the power amplifier, the power amplifier is configured to control the first speaker to convert an amplified audio signal to an acoustical signal for outputting by the first speaker.

11. The wearable device of claim 10, wherein the power supply module comprises a battery, and the battery is located an interior of the wearable device.

12. The wearable device of claim 10, wherein the power supply module comprises a power port, the power port is configured to connect a portable power source for allowing the portable power source to supply power for the wearable device.

13. The wearable device of claim 10, wherein the receiving module comprises an audio port, the audio port is configured to connect the electronic device via an audio cable for allowing the audio file of the electronic device to transmit to the receiving module.

14. The wearable device of claim 10, wherein the receiving module comprises a Bluetooth, the receiving module is configured to connect the electronic device via the Bluetooth for allowing the audio file of the electronic device to transmit to the receiving module.

15. The wearable device of claim 10, wherein the wearable device is a cap, and the power amplifier is located on an crown of the cap.

16. The wearable device of claim 10, wherein the wearable device further comprises a second speaker, and the first speaker and the second speaker are located on opposite sides of a brim of the cap.

17. The wearable device of claim 10, wherein the electronic device is a computer or a mobile phone.
